(19) United States
(12) Patent Application Publication
(10) Pub. No.: US 2005/0246185 A1
(43) Pub. Date: Nov. 3, 2005

(54) Business process for delivering health behavior prevention services

(76) Inventor: Richard L. Brown, Madison, WI (US)

Correspondence Address: FOLEY & LARDNER, 150 EAST GILMAN STREET, P.O. BOX 1497, MADISON, WI, 53701-1497, US

(21) Appl. No.: 10/835,045

(22) Filed: Apr. 29, 2004

(51) Int. Cl. G06F 17/60

(52) U.S. Cl. 705/1

(57) ABSTRACT

A health care system and method are provided to promote and to support maintenance of changes in health risk related behaviors. The method includes offering an individual a screening examination for a health risk related behavior, where the offering is performed using an offer communication technology. If the individual accepts the offer, a screening examination is conducted. Information from the screening examination is recorded in an electronic database. If a health risk related behavior is identified during the screening examination, an intervention with the individual is performed. Various communication technologies can be used to conduct the operations of the method. These communication technologies may be short messaging service text messaging, multimedia messaging service text messaging, instant messaging, e-mail, telephone, Internet, interactive voice response system, or mail. The electronic database may store the communications between preventive health care providers and the individual, and these communications may be accessible by preventive health care providers during later contacts.

### FIELD OF THE INVENTION

The present invention is related to the field of health care, and in particular to providing preventive care of individuals by inducing a modification in a health risk related behavior of the individual.

### BACKGROUND OF THE INVENTION

Research has shown that many of the most significant health problems in our society are caused in whole or in part by unhealthy lifestyles. In fact, the scientific literature documents that over 40% of Americans die from medical conditions that result directly from their choice to continue health risk related behaviors. Even where a health risk related behavior does not directly cause death, the health risk related behavior exacerbates illnesses when the individual chooses to continue the health risk related behavior. Most of these individuals fail to adhere to the medical regimens recommended by their physicians. The percentage of the population participating in health risk related behaviors, such as tobacco, alcohol, or drug use, unhealthy eating habits, and lack of exercise, remains high. Despite warnings, some individuals continue to practice unsafe sex. Still others fail to protect themselves adequately from sun exposure. Obesity has become such a significant problem that an estimated 300,000 deaths per year may be attributable to it.

The goal of health education programs is to motivate individuals to modify these health risk related behaviors in order to improve the current state of their health, improve longevity, and the quality of their life. The modification of health risk related behavior, however, provides benefits to more than just the individual. By reducing unhealthy and risky behaviors, there is less need for a visit to the doctor, for hospitalization, and for an emergency room visit and less need to purchase expensive medications. This leads to less absence from work, fewer workers compensation and disability claims, and improved productivity at work. This is particularly beneficial given that businesses have been confronted with double-digit increases in health insurance rates for three consecutive years. In response, more and more businesses simply drop health insurance coverage for their employees. As a result, health care has become an even more important concern for many workers than wages and job security. The rising costs of health care may further create a drag on the economy. This year's average premium increase for companies that continue to provide health insurance rose nearly 14%. Thus, there is a significant need to promote healthier lifestyles thereby decreasing health care costs.

In its simplest form, a health education program exposes an individual to information or to instructions relating to a selected health risk related behavior. The individual then chooses to modify his or her behavior by adhering to the information and instructions provided through the health education program. Many individuals, however, fail to respond to the simple provision of information concerning health risk related behaviors. Many individuals will modify their unhealthy and risky behaviors only in response to counseling interventions. Thus, more is needed than determining that an individual exercises health risk related behavior and then providing literature to that individual regarding that health risk related behavior. For an intervention to be successful, the specific motivational driver that causes each individual to participate in the unhealthy and risky behavior must be identified so that the behavior can be changed. Additionally, for a program to be successful, the program should be customizable for each individual to conform to their specific circumstances. Even after an individual initiates changes in their behavior, the individual needs continued feedback and support so that the individual does not lose the motivation to continue with their modified behavior. This type of program, however, should be provided in a cost effective and consistent manner using the latest scientific research findings.

For many reasons, including gaps in professional training, limited reimbursement, inadequate time, unsuitable clinical practice structures, and overwhelming need, behavioral prevention services have been inadequately or poorly provided in current health care settings. As a result, there are many missed opportunities to improve health and avert costly, intensive services. What is needed is an integrated system to promote healthier behaviors, improve the likelihood of success in modifying risky behavior, and decrease health care costs. What is further needed is a preventive health care system that utilizes the current, widely available spectrum of communication technologies to allow individuals a maximum of flexibility in working with a counselor or otherwise giving or receiving information or obtaining support in modifying their behavior. What is further needed is a system that utilizes the latest scientific research findings and continually applies quality assurance techniques to ensure that individuals receive the appropriate care.

### SUMMARY OF THE INVENTION

An exemplary embodiment of the invention relates to a method of providing preventive care for health risk related behaviors. The method comprises offering an individual a screening examination for a health risk related behavior, where the offering is performed using an offer communication technology. If the individual accepts the offer, a screening examination is conducted. Information from the screening examination is recorded in an electronic database. If a health risk related behavior is identified during the screening examination, an intervention with the individual is performed.

The method may further comprise:
continuing to offer the individual the screening examination until the individual completes the screening examination or refuses to complete the screening examination,
conducting a counseling session with the individual,
recording a summary of information from the counseling session in the electronic database,
recording a health history of the individual in the electronic database,
reporting the summary of information,
providing quality assurance,
providing ongoing support to the individual,
offering the individual a follow-up contact with a counselor,
selecting an ongoing contact system,
the counselor reviewing a contact communication from the individual,
recording the contact communication in the electronic database, and
the counselor contacting the individual when a contact algorithm recommends contact with the individual.

The various operations can be conducted using a variety of communication technologies. These communication technologies may be selected from the group including, but not limited to, short messaging service text messaging, multimedia messaging service text messaging, instant messaging, e-mail, telephone, Internet, interactive voice response system, and mail. Records of communications between preventive health care providers and individuals also may be stored in the electronic database. The electronic database may be an extensible Markup Language (XML) based database and may be accessible by a preventive health care provider during a contact with the individual.

The screening examination may be conducted using a screening protocol, and the intervention may be conducted using an intervention protocol. The counseling session may also be conducted using a counseling protocol. The summary of information gathered during the counseling session may be used to update the counseling protocol. The ongoing support may be conducted using an ongoing support protocol.

Another exemplary embodiment of the invention relates to a system of providing preventive care for health risk related behaviors. The system comprises an offer whereby an individual is offered a screening examination for health risk related behavior wherein the offer comprises an offer communication technology; a screening examination whereby, if the individual accepts the offer, the screening examination is conducted to identify a health risk related behavior; an electronic database comprising information from the screening examination; and an intervention whereby, if a health risk related behavior is identified during the screening examination, the intervention with the individual is conducted.

The system may further comprise:
a counseling session with the individual,
a summary information report,
a quality assurance questionnaire,
an ongoing contact system, and
a contact algorithm wherein the contact algorithm identifies when ongoing contact with the individual by a counselor is recommended.

The various operations are conducted using a variety of communication technologies. These communication technologies may be selected from the group including, but not limited to, short messaging service text messaging, multimedia messaging service text messaging, instant messaging, e-mail, telephone, Internet, interactive voice response system, and mail. Records of communications between preventive health care providers and individuals may be stored in the electronic database. The electronic database may be an XML based database and may be accessible by a preventive health care provider during a contact with the individual.

The screening examination may be conducted using a screening protocol, and the intervention may be conducted using an intervention protocol. The counseling session may also be conducted using a counseling protocol. The summary of information gathered during the counseling session may be used to update the counseling protocol. The ongoing support may be conducted using an ongoing support protocol.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is a diagram of communication technologies in accordance with an exemplary embodiment.

FIG. 2 is an overview diagram of a preventive care system in accordance with an exemplary embodiment.

FIG. 3a-3d are flow diagrams depicting operations in a preventive care system in accordance with an exemplary embodiment.

### DETAILED DESCRIPTION OF THE PREFERRED EMBODIMENTS

Most health care clinics operate on a reactive basis. These clinics administer care when individuals come to their clinical settings, when individuals telephone them, or when information from diagnostic tests is reported to them. When individuals do not make or keep appointments, do not seek care when there are important changes in their condition, or do not follow up on recommendations, adverse health outcomes are possible. A more pro-active approach wherein clinicians reach out to individuals provides positive health benefits. A pro-active approach includes, but is not limited to contacting prospective individuals to initiate a screening examination, ascertaining an individual's general preference for future contacts in terms of the mode of communication (i.e. e-mail versus telephone), the day of week, the time of day, and the frequency of contact, and contacting individuals that miss appointments for counseling or ongoing support. Pro-activity should be governed by individual preference. Thus, all requests to reduce or cease contact should be honored in an exemplary embodiment.

Many different communication technologies exist today for supporting a pro-active approach to health care. Both traditional telephones and, increasingly, cellular telephones provide nearly instantaneous communication with others worldwide. In addition to telephones, individuals now often have ready access to additional devices that allow communication with others. These devices include Personal Data Assistants (PDAs), such as those manufactured by PALM, Inc., Instant Messaging Devices (IMD), such as those manufactured by Blackberry, Inc., notebook computers, laptop computers, desktop computers, etc. These communication devices may be mobile and allow telephonic or wireless communication capabilities at short or long range. Thus, individuals can much more easily contact others when needed for support or for just conversation without a need for face-to-face contact.

Communication devices now communicate both voice calls and messages to other communication devices. Messages are communicated between devices using a number of different services including, but not limited to, e-mail in non-real time, Instant Messaging (IM) Service (IMS) in real time, and text messaging services which are a hybrid of e-mail and IM. Text messaging services provided for communication devices include the Short Messaging Service (SMS) and the Multimedia Messaging Service (MMS). SMS is a mechanism for delivering short messages over communication networks. SMS is a store and forward method of transmitting messages to and from mobiles devices and has become an essentially universal mobile data service. MMS conveys messages to and from mobile communication devices in a store-and-forward manner much like the SMS text messages, but MMS allows a combination of text, sounds, images, and video. MMS also supports pictures and interactive video.

Although both e-mail and SMS are “store and forward” systems that utilize a gateway to pass messages from senders to recipients, the most obvious difference between the two is the length and complexity of the messages that are permissible. SMS messages currently are generally limited to between 80 and 500 characters depending on the service provider. A typical SMS message consists of about 120 characters. Messages generated by SMS, however, are immediately delivered directly to the device; whereas, e-mail delivery may incur additional delivery delays at a mail server. While e-mail allows the attachment of files, the imbedding of images, and may use HTML, SMS messages generally are limited to text and numeral displays. MMS, on the other hand, provides support for not just text, but also sounds, images, and video for more complex message transmission.

E-mail has become a necessary tool and is by far the most popular messaging service currently in use in North America. There are millions of e-mail accounts today with the average person receiving about thirty e-mails each day. In many companies, e-mail is the preferred method of communication—even between people that sit relatively close to each other. Many communication systems offer e-mail service over SMS and some systems now offer e-mail service over MMS. The user of an SMS or MMS enabled mobile communication device can choose to have an email address assigned to the device, allowing friends and colleagues to send e-mail messages directly to the device using either native e-mail support at the device or SMS or MMS capability for formatting the messages. Thus, it is possible to send e-mail messages from a mobile communication device to any e-mail address using multiple formats. Alternatively, the messages may be received on a non-mobile communication device such as a desktop computer.

On the other hand, the Instant Messaging Service (IMS), made popular by AOL Instant Messenger, provides a user access to a virtually real-time text conversation (or chat) with people who are simultaneously connected to the Internet. SMS messages are immediate, but not virtually real-time. SMS messages are sent to and processed by a Short Message Service Center, which then delivers the message to the intended recipient's communication device. Mobile communication devices now also support IMS based on SMS technology giving people the ability to join public chat rooms, or create “friends lists” similar to IM software deployed on the Internet. Using IM, a user can monitor other people's status or notify a user when another person comes online. Mobile users can have access to their buddy lists and can see who is online just as with Personal Computer (PC) based IM. When offline, mobile IM users can be invited to IM via an SMS text message sent by a friend from an IM application on a communication device. Buddy lists can show if somebody is online on a mobile communication device or on a PC.

The Internet is a wide area network that connects hundreds of thousands of computers and smaller sub-networks world-wide. Businesses, government bodies and entities, educational organizations, and even individuals publish information or data organized in the form of websites. A website may comprise multiple web pages that display a specific set of information and may contain links to other web pages with related or additional information. Some web pages include multiple web pages that are displayed in combination. Each web page is identified by a Uniform Resource Locator (URL) that includes the location or address of the computer that contains the resource to be accessed in addition to the location of the resource on that computer. The type of file or resource depends on the Internet application protocol. For example, the Hypertext Transfer Protocol (HTTP) describes a web page to be accessed with a web browser application. The file accessed may be a simple text file, an image file, an audio file, a video file, an executable, a common gateway interface application, a Java applet, or any other file supported by HTTP. A web page may include a form or questionnaire for an individual to fill out. The File Transfer Protocol (FTP) describes a resource comprising a file to be downloaded from the computer. Using the Internet, a user may access vast amounts of educational and informational material.

Private documents may be transmitted or received using Internet protocols such as secure sockets layer (SSL) and secure HTTP (S-HTTP). Both protocols have been accepted as standards. The secure sockets layer is a protocol developed by Netscape®. SSL uses a private key to encrypt data that is transferred over the SSL connection. Many Web sites use SSL to obtain confidential user information, such as credit card numbers. By convention, URLs that require an SSL connection start with https: instead of http. Whereas SSL creates a secure connection between a client and a server over which any amount of data can be sent securely, S-HTTP transmits individual messages securely. Before entering a secure web page, a user may be prompted for a username and a password that has been defined between the user and the web site provider. Thus, private information can be posted to the Internet, but only specific individuals may have access to that information. Medical records, in particular, not only warrant protection, but require protection based on regulations promulgated under the Health Insurance Portability and Accountability Act (HIPAA). Thus, where medical records are posted using electronic communication methods, special care must be used to ensure that confidentiality of the information is maintained.

An Interactive Voice Response (IVR) System is a software application that accepts a combination of voice telephone input and touch-tone keypad selection and provides appropriate responses in the form of voice, fax, callback, e-mail, and other messaging systems. IVR is usually part of a larger application that includes access to an electronic database containing information relevant to the purpose of the IVR system. An IVR application provides pre-recorded voice responses for specific situations, keypad signal logic selectable by a user, access to relevant data, and the ability to record voice input for later processing for example by a counselor. IVR applications can route a call to a human being who can view data related to the caller on a computer display or to a voice mail or other messaging system. IVR systems provide information and question/answer decision logic and may also provide speech recognition technology, message management, and automated information retrieval. Thus, IVR systems also provide a technology for communicating with others either using a phone or the Internet.

Use of an electronic database maximizes continuity of care for an individual and provides a mechanism for tracking an individual's progress. In an exemplary embodiment, records of communications with an individual as part of a preventive care system for health risk related behavior may be maintained in an electronic database regardless of the communication purpose and the communication technology used (telephone counseling, on-going support using an IVR system, the Internet, mail, e-mail, etc.). Additionally, in an exemplary embodiment, the database is protected by the most secure systems available and complies with HIPAA regulations. For ease of use and portability of the information, the database is formatted using XML, in an exemplary embodiment. An XML formatted database exceeds traditional data storage mechanisms in terms of convenience, ease of development, and performance. Use of XML format for records promotes the distribution of an open source health care record allowing use of the information by multiple health care providers. Using the appropriate security protocols, the database may be available to select individuals using an IVR system, the Internet, or a computer electronically connected to the database.

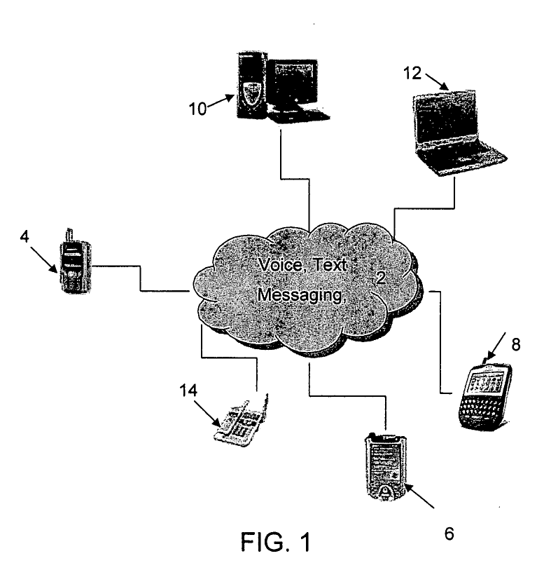

FIG. 1 illustrates example communication devices for communicating with others. The communication technologies 2 may be through voice, text messaging (including, but not limited to, e-mail, IM, SMS, and MMS), the Internet, and an IVR system. An additional communication technology (not shown) is a mail service. The communication devices include, but are not limited to, a cellular telephone 4, a PDA 6, an IMD 8, A desktop computer 10, a notebook computer 12, and a telephone 14.

To enhance continuity of care, to help counselors recall important contextual information from session to session, and to facilitate the transfer of care of an individual from one preventive health care provider to another, the database system, in an exemplary embodiment, records and makes accessible by a counselor the following information for each individual:
Demographic information,
Information on family, close friends, and the individual's living situation,
Stresses on the individual and supports for the individual,
Clinical information concerning medical problems and both current and prior medications,
The life goals and responses by the individual concerning the impact of unhealthy behaviors,
Behavior change plans,
Longitudinal data recorded at multiple time points on the individual's health behaviors, self-reported risk for relapse, the effectiveness of various components of their plan, counselor contacts, and important life events.

Additional or fewer informational data items may be provided to the preventive health care provider through the database without deviating from the spirit of the invention.

Algorithms and protocols, informed by current scientific research findings, may be used, in an exemplary embodiment, to guide all responses from the preventive health care system providers. Responses include, but are not limited to, responses by counselors, by the IVR system, by Internet based services, by screening examiners, etc. All aspects of the preventive health care system may be guided by the same algorithms with adjustment only for the capabilities of the communication technology used. The same algorithms guide the delivery of screening, intervention, counseling, ongoing support, and referral services. These algorithms may be translated into protocols that guide providers in delivering preventive health care services through whatever communication technology is selected by the individual. Such protocols include, but are not limited to, a screening protocol, an intervention protocol, a counseling protocol, and an ongoing support protocol.

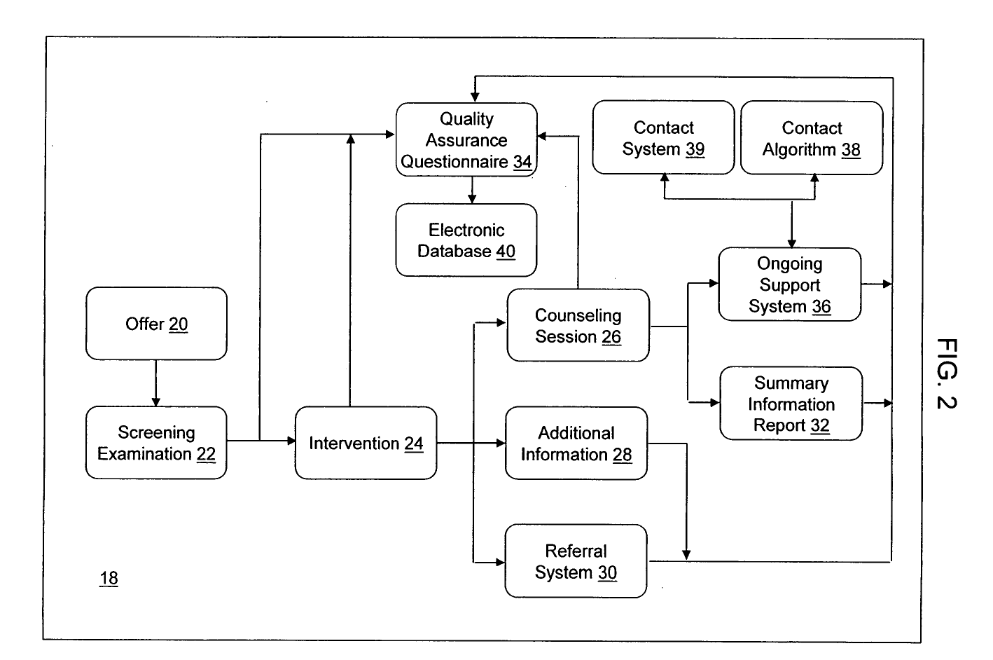

The processes in a preventive clinical care system 18 are shown, in an exemplary embodiment, in FIG. 2. The processes include: an offer 20, a screening examination 22, an intervention 24, a counseling session 26, an ongoing support system 36, and a referral system 30. The offer 20 may be initiated proactively by a health care provider instead of by the individual. A screening examination 22 identifies, using a set of brief questions, whether individuals are engaged in particular behaviors known to increase the risk for adverse health events and outcomes. An intervention 24 involves limited efforts to provide feedback on the possible health effects of the behavior, education on how the behavior can lead to harm, a recommendation for lifestyle changes, and a plan negotiated for effecting the lifestyle change. The plan for change is secured in an agreement that defines the change in concrete terms and may define follow-up contacts with the individual to check on progress and reinforce advice. An intervention protocol may be used to assist a preventive health care provider. A counseling session 26 involves discussions of greater duration and depth than the intervention 24 and is typically provided by trained counselors; whereas an intervention may be provided by a counselor or by an algorithmically driven communication technology, such as a website or IVR. An ongoing support system 36 provides continued interaction with an individual to ensure that the individual remains committed to changing their lifestyle. A referral system 30 provides an individual with additional resources that may be available to address the specific needs of the individual depending upon the health risk related behavior involved.

A combination of communication methods may be used to deliver care efficiently and in accord with each individuals' preferences. An individual may be offered the screening examination 22 by telephone, by IVR system, through text messaging, by mailed invitation, or by any other communication technology. The screening examination 22 may be conducted using an IVR system, an Internet website, text messaging, a telephone, a written questionnaire, or any other communication technology. A screening protocol may be used to assist a preventive health care provider in identifying a health risk related behavior of an individual. In an exemplary embodiment, the intervention 24 and, if appropriate, the referral 30 immediately follow the screening examination 22 and use the same communication technology. Individuals with health risk related behaviors may be invited to speak to a counselor 26 and/or to review additional information 28. The counselor may communicate with the individual using a telephone, through text messaging, or any other communication technology. In an exemplary embodiment, the counselor communicates with the individual using a telephone. The additional information 28 may be accessible from a website or may provided by mail, by e-mail, or by any other communication technology. In an exemplary embodiment, the database 40 may store the additional information 28. Individuals may be offered a follow-up contact as part of an ongoing support system 36. In an exemplary embodiment, a follow-up contact is provided approximately one month later when an individual declines an invitation to speak to a counselor.

The counseling session 26 may use the technique of motivational interviewing. Motivational interviewing is a counseling method of growing popularity that helps promote a commitment to change. Motivational interviewing helps individuals take stock of the positive and negative aspects of their unhealthy behavior, their satisfaction with their lives, how they might wish their lives to be different, goals for the future, and how their current behavior or a behavior change would fit in with their priorities and goals for the future. Motivational interviewing also includes efforts to bolster a sense of self-efficacy and the belief that individuals can change their behavior if they choose. For individuals who are committed to change their behavior, further motivational interviewing involves helping them construct a plan for implementing and maintaining the behavior change including consideration of triggers and how to manage or avoid them, formal and informal support mechanisms, contingency plans for an impending relapse, and options for ongoing support. In an exemplary embodiment, counseling services are performed by counselors using a telephone.

As significant new information is obtained, counselors produce a summary information report 32 with information on the individual's life situation, goals, the degree to which their current behaviors will help or hinder them in attaining their goals, the pros and cons of continuing versus changing their behaviors, and change plans. These reports may be conveyed to the individual using e-mail, mail, or a password protected Internet website. Such reports are intended to help individuals take stock of their situations, their future, and their options and plans for improving their lives. When conducting counseling sessions, counselors, generally wearing headphones, may be provided with protocol-driven prompts that appear on a computer screen. As information is collected, counselors may enter information into a form presented on the computer screen. Such information may be stored in the electronic database 40 and used by the counseling algorithm to determine future prompts by modifying the counseling protocol. The counseling protocol may be used to assist a counselor in providing the appropriate care to the individual.

The ongoing support system 36 consists of services over an extended period of time where individuals provide periodic updates on their behaviors and their adherence to their plans to change, and reevaluate and refine their change plans. For ongoing support, the individual may be asked to select a contact system 39 that includes a contact interval, a contingency contact technology, and a contact communication technology. The contact interval includes the time interval at which the individual reports on their behaviors, the effectiveness of various aspects of their change plan, their risk level for resuming the undesirable behavior, and their desire for additional assistance. In an exemplary embodiment, counselors review this data daily. A contact algorithm 38 may signal counselors when attempts to contact the individual are advisable. The contingency contact technology includes the method used by the preventive health care provider to contact the individual, for example, when the individual does not contact the provider as scheduled. The contingency contact technology may include, but is not limited to, the telephone, the Internet, text messaging, e-mail, or an IVR system. In an exemplary embodiment, the contingency contact technology may be an IVR system that contacts the individual. The contact communication technology includes the method used by the individual to contact the preventive health care providers. The communication technology may include, but is not limited to, the telephone, the Internet, text messaging, e-mail, or an IVR system. The individual then uses the selected communication technology to send a contact communication to the preventive health care provider at the specified contact interval. In an exemplary embodiment, the communication technology may be an IVR system that the individual interacts with in providing an update or report concerning their current behavior. The contact communications may be recorded in the database 40. An ongoing support protocol may be used to assist a preventive health care provider in providing ongoing support of an individual.

Individuals may be offered additional information 28 on their behaviors. The informational materials generally are tailored to the individual's level of commitment to change and may include lists and explanations of potential adverse health effects and other effects of their behaviors, worksheets to identify positive and negative aspects of behaviors, worksheets for listing life goals and taking stock whether their unhealthy behavior will foster or interfere with such goals, and worksheets for developing, for monitoring, for implementing, for evaluating, and for refining behavior change plans.

Referral 30 involves suggesting that individuals seek services from other sources. Referrals for services of higher intensity are offered to individuals who show insufficient clinical improvement in response to services of lower intensity, or to individuals who, because of various clinical factors, are not expected to respond to services of lower intensity. Referrals may also be suggested for individuals who would benefit from contact with other professionals with different expertise. Such resources may include, but are not limited to, smoking cessation classes, weight loss centers, health clubs, twelve-step programs, dieticians, and mental health care providers. When individuals desire referrals, information is readily available through the electronic database 40. A referral protocol may be used to assist a preventive health care provider in recommending the appropriate referral service and circumstances.

An individual's current health care professionals may refer individuals for service under the preventive health care system. Such referrals might come, for example, for a patient with coronary artery disease who continues to smoke, or for an obese patient with diabetes who is not losing weight. After receiving a referral from an individual's health care professional, the preventive health care system, in an exemplary embodiment, proactively offers the individual a screening examination. Individuals may be given the option to have reports on their participation and progress sent to one or more of their health care professionals. Individuals may further have the option of limiting reports that cover certain behaviors. In an exemplary embodiment, no information is released without the individual's written consent.

With an individual's permission, a list of their medical conditions and their medications is obtained from their health care professional. Such information may be used to enhance counselors' understanding of an individual's life and to identify possible motivators to change behaviors, for example, a diagnosis of asthma may be relevant as the individual deliberates on whether to stop smoking, and taking prescription sedatives may be relevant as the individual deliberates whether to decrease alcohol use.

At the completion of a counseling session or any other contact with an individual, a quality assurance questionnaire 34 may be filled out by the individual or by the preventive health care provider. The quality assurance questionnaire 34 comprises a set of questions designed to determine the individual's satisfaction with the care provided including, but not limited to, questions on what they liked best and changes they would recommend. The care provided may include the additional information 28 provided and the referral system 30. Satisfaction data on each counselor and system component may be recorded in the database 40, analyzed and reviewed periodically, and used to prompt improvements in the preventive health care system. Satisfaction data on specific counselors may be reported back to counselors and their supervisors in aggregate. Counselors with lower scores than their peers may undergo more vigorous review. Failure to improve satisfaction scores with remediation may result in dismissal.

Further in support of quality assurance, a counseling session may be audiotaped with an individual's permission. Some audiotapes may be randomly selected for review by a counseling supervisor or by the counselor. As part of the quality assurance program, counseling supervisors may score each session for adherence to protocol and for adherence to motivational interviewing principles, including conveying warmth, respect, empathy, and partnership. Counselors who continue to score lower than peers despite remediation may be dismissed.

Through data collected during ongoing support of an individual, the service effectiveness of promoting change in various health behaviors can be determined. Periodic reports on effectiveness and client satisfaction may be sent to all customers to inform them of the preventive health care system effectiveness. The quality assurance information may also be stored in the electronic database 40.

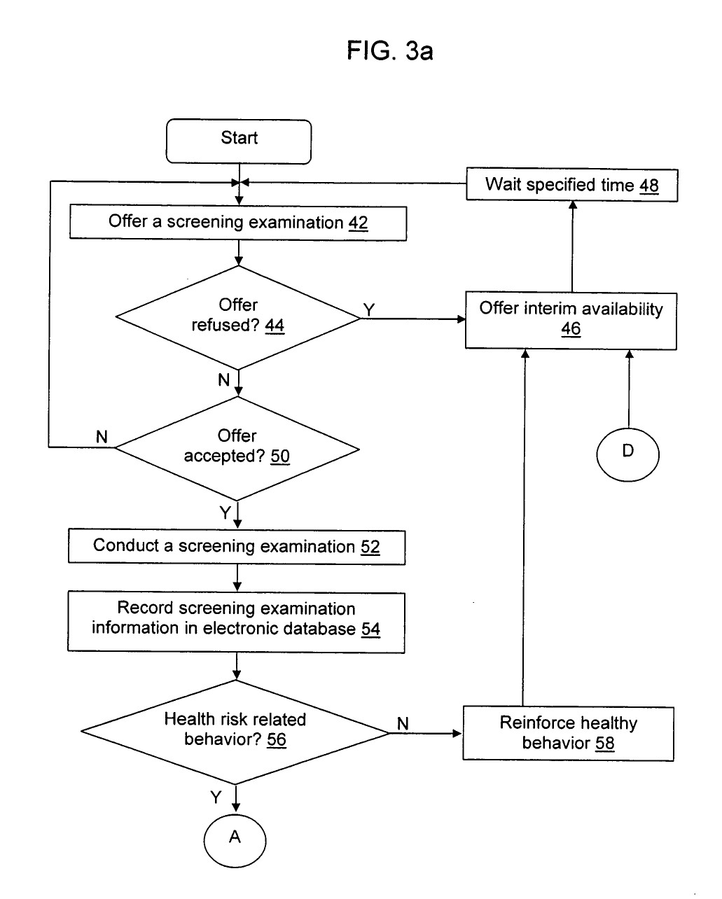

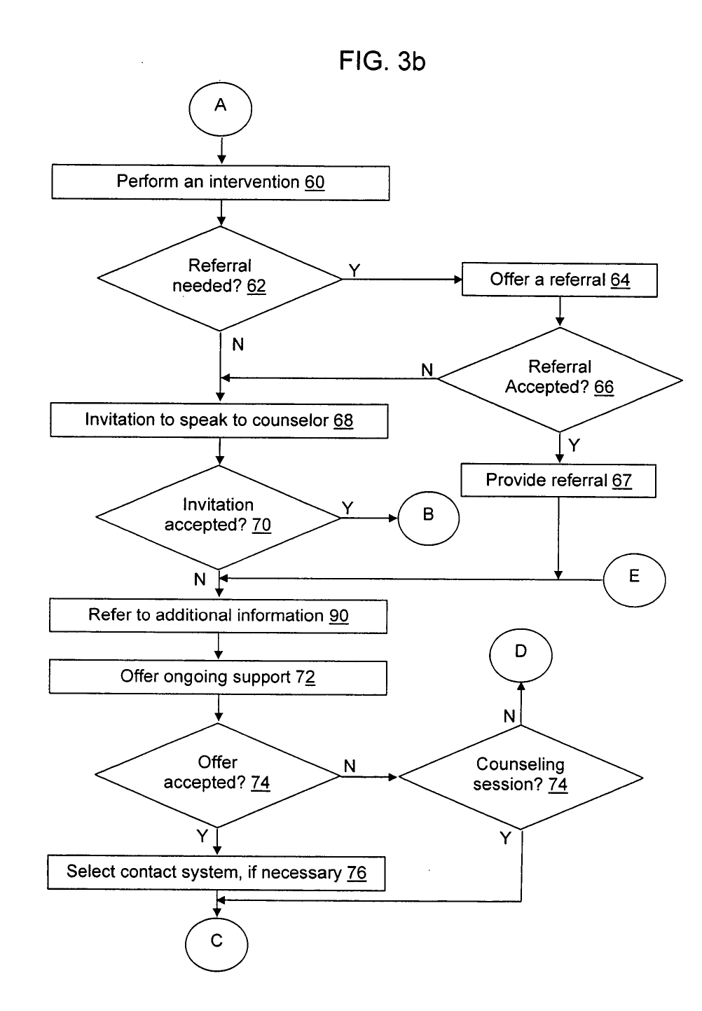

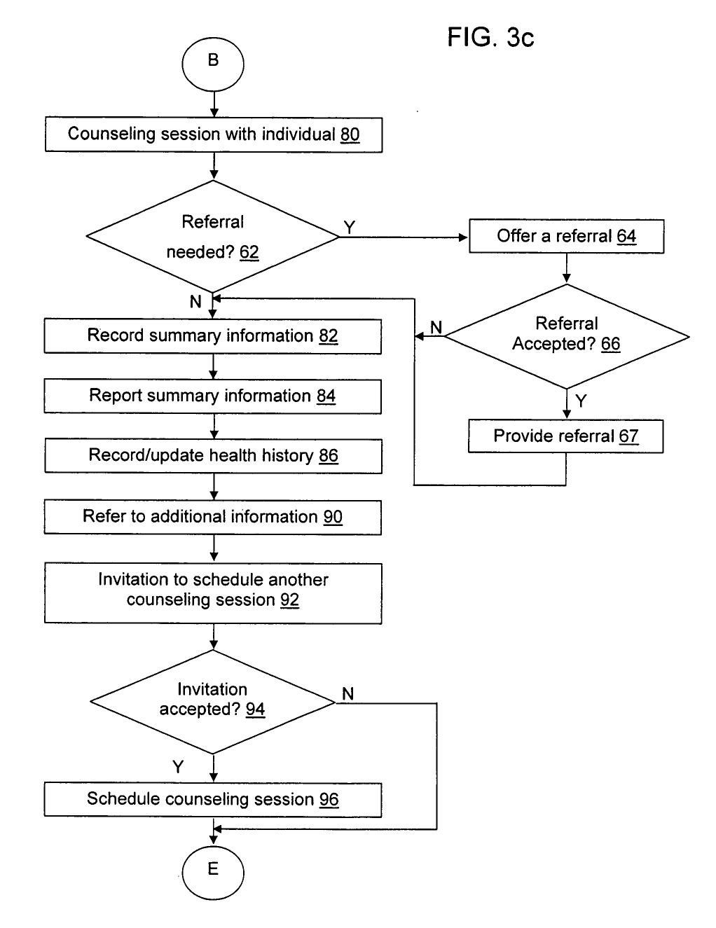

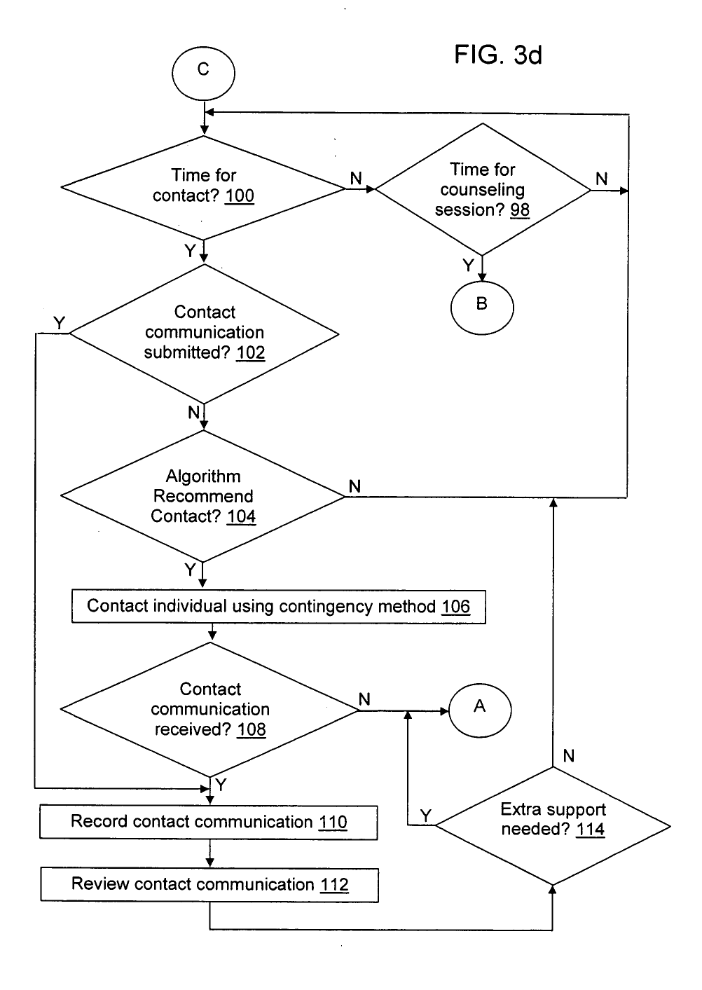

FIGS. 3a-3d illustrate flow diagrams that depict operations in a preventive health care system in accordance with an exemplary embodiment. At operation 42, the individual is offered a screening examination possibly as a result of a referral from the individual's current health care professional. The screening examination may also be offered as a result of the individual's own initiative. The screening examination may also result from other initiatives. A test at operation 44 determines if the individual has refused the offer. If the offer is refused, at operation 46, an offer of availability of the preventive health care system to the individual is made. At operation 48, a specified period of time passes before the offer of a screening examination is renewed. In an exemplary embodiment, the offer of a screening examination may be renewed in a year. The offer, however, may be renewed more frequently based on, for example, a recommendation by a current health care professional.

If the offer is not refused, the test at operation 50 determines if the offer is accepted. If the offer is not accepted, the offer is renewed until the offer is refused at operation 44. If the offer is accepted, the screening examination is conducted at operation 52. Information obtained during the screening examination is recorded in the electronic database at operation 54. The test at operation 56 determines if a health risk related behavior was identified during the screening examination. If a health risk related behavior was not identified, the healthy behavior of the individual is reinforced. At operation 46, an offer of availability of the preventive health care system to the individual is made should they need reinforcement of the healthy behavior in the future. At operation 48, a specified period of time passes before the offer of a screening examination may be renewed.

If a health risk related behavior is identified, an intervention is performed at operation 60. A test at operation 62 determines if a referral to other services is needed. If a referral is needed, the individual is offered a referral to other resources at operation 64. A test at operation 66 determines if the referral is accepted. If the referral is accepted, a referral is provided at operation 67. Processing continues at operation 90. If the referral is not accepted at operation 66, the individual is invited to speak to a counselor at operation 68. The test at operation 70 determines if the invitation to speak to a counselor is accepted.

If the invitation is accepted, a counseling session with the individual is conducted at operation 80. The test at operation 62 determines if a referral to other services is needed despite counseling of and intervention with the individual. If a referral is needed, the individual is offered a referral to other resources at operation 64. A test at operation 66 determines if the referral is accepted. If the referral is accepted, a referral is provided at operation 67. Summary information gathered during the counseling session is recorded in the electronic database at operation 82. The summary information may also be reported at operation 84 in a summary information report. In an exemplary embodiment, access to the summary information report is limited to the individual, the preventive health care providers, and the individual's current health care professionals. A health history of the individual may also be recorded in the database or updated if the health history has already been recorded in the database at operation 86. At operation 90, the individual is referred to additional information relating to their health risk related behavior. The individual is invited to schedule another counseling session at operation 92. The next counseling session may be offered at an interval selected by the individual. In exemplary embodiments, the interval may be one week, two weeks, or four weeks. The test at operation 94 determines if the invitation for additional counseling sessions is accepted by the individual. If the invitation is accepted, an additional counseling session is scheduled at operation 96.

Processing continues at operation 90 wherein the individual may be referred to additional information relating to their health risk related behavior. At operation 72, the individual is offered ongoing support in modifying their health risk related behavior. The test at operation 74 determines if the invitation is accepted. If the invitation is not accepted and, if the individual does not have a future counseling session scheduled as determined at operation 75, an offer of availability of the preventive health care system to the individual is made should they need assistance in the future. At operation 48, a specified period of time passes before the offer of a screening examination may be renewed.

If the invitation of ongoing support is accepted, the individual selects a contact system at operation 76. The contact system includes the selection of a contingency contact technology for communication with the individual, a communication technology for communication with a preventive health care provider, and a contact interval. The test at operation 100 determines if it is time for a contact communication with the individual. If it is not time for a contact with the individual, the test at operation 98 determines if it is time for a counseling session with the individual. If it is time for a counseling session, processing continues at operation 80. If it is not time for either a contact (ongoing support) or a counseling session with the individual, processing continues to test for the next time for contact or for counseling.

If it is time for the next follow-up contact, the test at operation 102 determines if the individual has already contacted the preventive health care provider by submitting a contact communication concerning the individual's current status. If the individual has not contacted the preventive health care provider, an algorithm determines if contact with the individual by a counselor is recommended. The test at operation 104 determines if the algorithm recommends that the individual be contacted by a counselor or other preventive health care provider. If the algorithm does not indicate that contact is advisable, the process continues to test for the next time for contact or for counseling. If the algorithm recommends contact, the individual is contacted using the contingency contact technology at operation 106. The test at operation 108 determines if a contact communication has been received from the individual. If no contact communication is received, processing continues to operation 60 where another intervention with the individual is performed. At operation 110, a record of the contact communication is recorded in the database. At operation 112, a counselor or preventive health care provider reviews the contact communication. In an exemplary embodiment, a counselor reviews the contact communication the day the communication is received. The test at operation 114 determines if the individual needs additional support. If additional support is needed, processing continues to operation 60 where another intervention with the individual is performed. If no additional support is needed, processing continues to operation 100 which tests for the next time for contact or for counseling with the individual.

It is understood that the invention is not confined to the particular embodiments set forth herein as illustrative, but embraces all such modifications, combinations, and permutations as come within the scope of the following claims. The present invention is not limited to a particular operating environment. Those skilled in the art will recognize that the system and methods of the present invention may be advantageously operated on different platforms. Thus, the description of the exemplary embodiments is for purposes of illustration and not limitation.

1. A method of promoting and of supporting maintenance of changes in health risk related behaviors, the method comprising:
offering an individual a screening examination for a health risk related behavior using an offer communication technology;
if the individual accepts the offer, conducting the screening examination;
recording information from the screening examination in an electronic database; and
if a health risk related behavior is identified during the screening examination, performing an intervention with the individual.

2. The method of claim 1, wherein the offer communication technology is a technology selected from the group consisting of e-mail, a telephone, an interactive voice response system, and mail.

3. The method of claim 1, wherein conducting the screening examination comprises using a screening protocol.

4. The method of claim 1, wherein performing the intervention comprises using an intervention protocol.

5. The method of claim 1, wherein the electronic database is an extensible Markup Language based database.

6. The method of claim 1, wherein the electronic database is accessible by a counselor during a counseling session with the individual.

7. The method of claim 1, further comprising recording a health history of the individual in the electronic database.

8. The method of claim 1, wherein conducting the screening examination comprises using a communication technology, and further wherein the communication technology is a technology selected from the group consisting of short messaging service text messaging, multimedia messaging service text messaging, instant messaging, e-mail, telephone, Internet, and interactive voice response system.

9. The method of claim 1, wherein performing the intervention comprises using a communication technology, and further wherein the communication technology is a technology selected from the group consisting of short messaging service text messaging, multimedia messaging service text messaging, instant messaging, e-mail, telephone, Internet, and interactive voice response system.

10. The method of claim 1, further comprising continuing to offer the individual the screening examination until the individual completes the screening examination or refuses to complete the screening examination.

11. The method of claim 1, further comprising inviting the individual to review additional information.

12. The method of claim 11, further comprising reviewing the additional information using a communication technology, wherein the communication technology is a technology selected from the group consisting of short messaging service text messaging, multimedia messaging service text messaging, instant messaging, e-mail, Internet, and mail.

13. The method of claim 1, further comprising inviting the individual to communicate with a counselor.

14. The method of claim 13, further comprising conducting a counseling session with the individual.

15. The method of claim 14, wherein conducting the counseling session comprises using a communication technology, and further wherein the communication technology is a technology selected from the group consisting of short messaging service text messaging, multimedia messaging service text messaging, instant messaging, e-mail, and phone.

16. The method of claim 14, wherein conducting the counseling session comprises using a counseling protocol.

17. The method of claim 14, further comprising recording a summary of information from the counseling session in the electronic database.

18. The method of claim 17, further comprising reporting the summary of information.

19. The method of claim 18, wherein reporting the summary of information comprises using a communication technology, and further wherein the communication technology is a technology selected from the group consisting of e-mail, Internet, and mail.

20. The method of claim 19, further comprising updating a counseling protocol using the summary of information.

21. The method of claim 1, further comprising providing quality assurance.

22. The method of claim 1, further comprising providing ongoing support to the individual.

23. The method of claim 22, further comprising conducting the ongoing support using an ongoing support protocol.

24. The method of claim 22, wherein the ongoing support is a service selected from the group consisting of counseling the individual using a telephone, providing an Internet website with additional information, providing an interactive voice response system, and providing a text messaging service.

25. The method of claim 24, wherein the text messaging service is a service selected from the group consisting of a short messaging service, a multimedia messaging service, an instant messaging service, and e-mail.

26. The method of claim 1, further comprising offering the individual a follow-up contact.

27. The method of claim 26, further comprising selecting an ongoing contact system wherein the ongoing contact system comprises a contact interval, a contact communication, a contingency contact technology, and a contact communication technology.

28. The method of claim 27, wherein the contact communication technology is a technology selected from the group consisting of short messaging service text messaging, multimedia messaging service text messaging, instant messaging, e-mail, telephone, Internet, interactive voice response system, and mail.

29. The method of claim 27, wherein the contingency contact technology is a technology selected from the group consisting of short messaging service text messaging, multimedia messaging service text messaging, instant messaging, e-mail, telephone, Internet, interactive voice response system, and mail.

30. The method of claim 27, further comprising a counselor reviewing the contact communication from the individual.

31. The method of claim 27, further comprising recording the contact communication in the electronic database.

32. The method of claim 27, further comprising a counselor contacting the individual when a contact algorithm recommends contact with the individual.

33. A system of promoting and of supporting maintenance of changes in health risk related behaviors, the system comprising:
an offer for a screening examination for health risk related behavior conducted using an offer communication technology;
if the individual accepts the offer, a screening examination to identify a health risk related behavior;
an electronic database comprising information obtained during the screening examination; and
if a health risk related behavior is identified during the screening examination, an intervention.

34. The system of claim 33, wherein the offer communication technology is a technology selected from the group consisting of e-mail, a telephone, an interactive voice response system, and mail.

35. The system of claim 33, wherein the screening examination is conducted using a screening protocol.

36. The system of claim 33, wherein the intervention is conducted using an intervention protocol.

37. The system of claim 33, wherein the electronic database is an extensible Markup Language based database.

38. The system of claim 33, wherein the electronic database is accessible by a counselor during a counseling session with the individual.

39. The system of claim 33, wherein the electronic database further comprises a health history of the individual.

40. The system of claim 33, wherein the screening examination is conducted using a communication technology, and further wherein the communication technology is a technology selected from the group consisting of short messaging service text messaging, multimedia messaging service text messaging, instant messaging, e-mail, telephone, Internet, and interactive voice response system.

41. The system of claim 33, wherein the intervention is conducted using a communication technology, and further wherein the communication technology is a technology selected from the group consisting of short messaging service text messaging, multimedia messaging service text messaging, instant messaging, e-mail, telephone, Internet, and interactive voice response system.

42. The system of claim 33, further comprising an invitation to review additional information, wherein the additional information is accessed using a communication technology, and further wherein the communication technology is a technology selected from the group consisting of short messaging service text messaging, multimedia messaging service text messaging, instant messaging, e-mail, Internet, and mail.

43. The system of claim 33, further comprising an invitation to communicate with a counselor.

44. The system of claim 43, further comprising a counseling session conducted with the individual.

45. The system of claim 44, wherein the counseling session is conducted using a communication technology, and further wherein the communication technology is a technology selected from the group consisting of short messaging service text messaging, multimedia messaging service text messaging, instant messaging, e-mail, and phone.

46. The system of claim 44, wherein the counseling session is conducted using a counseling protocol.

47. The system of claim 44, wherein the electronic database further comprises a summary of information from the counseling session.

48. The system of claim 47, further comprising a summary information report.

49. The system of claim 48, wherein the summary information report is reported using a communication technology, and further wherein the communication technology is a technology selected from the group consisting of e-mail, Internet, and mail.

50. The system of claim 47, wherein the summary of information is used to update a counseling protocol.

51. The system of claim 33, further comprising a quality assurance questionnaire.

52. The system of claim 33, further comprising an ongoing contact system.

53. The system of claim 52, wherein the ongoing contact system comprises a contact interval, a contact communication, a contingency contact technology, and a contact communication technology.

54. The system of claim 53, wherein the contact communication technology is a technology selected from the group consisting of short messaging service text messaging, multimedia messaging service text messaging, instant messaging, e-mail, telephone, Internet, interactive voice response system, and mail.

55. The system of claim 53, wherein the contingency contact technology is a technology selected from the group consisting of short messaging service text messaging, multimedia messaging service text messaging, instant messaging, e-mail, telephone, Internet, interactive voice response system, and mail.

56. The system of claim 53, wherein the contact communication is reviewed by a counselor.

57. The system of claim 53, wherein the electronic database further comprises the contact communication.

58. The system of claim 53, further comprising a contact algorithm wherein the contact algorithm identifies when ongoing contact with the individual by a counselor is recommended.
